(19) United States
(12) Patent Application Publication
(10) Pub. No.: US 2021/0239970 A1
(43) Pub. Date: Aug. 5, 2021

(54) OPTICAL SYSTEM AND IMAGE DISPLAY APPARATUS

(71) Applicant: CANON KABUSHIKI KAISHA, Tokyo (JP)

(72) Inventor: Ryoji Kondo, Kanagawa (JP)

(21) Appl. No.: 17/150,143

(22) Filed: Jan. 15, 2021

(30) Foreign Application Priority Data
Jan. 31, 2020 (JP) 2020-015875

(51) Int. Cl. G02B 27/00; G02B 27/28; G06F 1/16

(52) U.S. Cl. CPC G02B 27/0025; G06F 1/163; G02B 27/286

(57) ABSTRACT

An optical system configured to guide light from a display element configured to display an image to an observer includes, in order from a side of the display element, a polarizing plate, a first phase plate, a first lens unit, a half-transmissive reflective film, a second phase plate, and a reflective and transmissive polarizing plate. The first lens unit includes a lens made of a resin material. Some conditions are satisfied.

### BACKGROUND OF THE INVENTION

### Field of the Invention

The present invention relates to an image display apparatus suitable for a head mounted display (HMD) or the like for magnifying and observing an image on an image display element via an eyepiece optical system.

### Description of the Related Art

Head mounted displays have been developed for virtual reality (VR) or for enjoying large-screen observation images alone. An image display apparatus used for the head mounted display or the like is demanded to include an eyepiece optical system with a wide angle of view in order to perform natural observation and increase a sense of presence (or realism). Moreover, a head mounted type image display apparatus is demanded to be thin and lightweight.

An eyepiece optical system configured to fold an optical path using polarized light has conventionally been proposed in order to display an image with a wide angle of view. The eyepiece optical system using polarized light has a short focal length, and can reconcile both a thin profile and a wide angle of view. However, if a plastic lens is used to reduce the weight of the eyepiece optical system that uses polarized light, the desired polarization state cannot be obtained due to the birefringence in the plastic lens, ghosts and dimming occur, and a comfortable observation is difficult.

Japanese Patent Laid-Open No. 2019-053152 and PCT Domestic publication No. 2018-508800 disclose an eyepiece optical system that folds an optical path using polarized light. The eyepiece optical system disclosed in Japanese Patent Laid-Open No. 2019-053152 reduces the luminance unevenness by setting a direction of a transmission axis of a half-transmissive polarizing plate (polarizer) in the eyepiece optical system to a direction in which the eyes are aligned. The eyepiece optical system disclosed in PCT Domestic publication No. 2018-508800 realizes a wide angle of view by utilizing a polarizing element on a curved surface.

However, the eyepiece optical system disclosed in Japanese Patent Laid-Open No. 2019-053152 and PCT Domestic publication No. 2018-508800 cannot reduce the ghosts generated by birefringence.

### SUMMARY OF THE INVENTION

The present invention provides an optical system and an image display apparatus advantageous in reducing ghosts in an eyepiece optical system having a. wide angle of view and light weight using polarized light.

An optical system according to one aspect of the present invention configured to guide light from a display element configured to display an image to an observer includes, in order from a side of the display element, a polarizing plate, a first phase plate, a first lens unit, a half-transmissive reflective film, a second phase plate, and a reflective and transmissive polarizing plate. The first lens unit includes a lens made of a resin material. The following conditions are satisfied:

ΔP1≠λ/4

3λ/20≤ΔP1+ΔL1≤7λ/20

where λ (nm) is a wavelength of the light, ΔP1 is a phase difference given by the first phase plate to the light, and ΔL1 is a phase difference given by the first lens unit to the light.

An optical system according to another aspect of the present invention configured to guide light from a display element configured to display an image to an observer includes, in order from a side of the display element, a polarizing plate, a first phase plate, a half-transmissive reflective film, a lens unit, a second phase plate, and a reflective and transmissive polarizing plate. The lens unit includes a lens made of a resin material. The following conditions are satisfied:

3λ/20≤ΔP2+ΔL≤7λ/20

ΔP2≠λ/4

where λ (nm) is a wavelength of the light, ΔP2 is a phase difference given by the second phase plate to the light, and ΔL is a phase difference given by the lens unit to the light.

Further features of the present invention will become apparent from the following description of exemplary embodiments with reference to the attached drawings.

### BRIEF DESCRIPTION OF THE DRAWINGS

FIG. 1 is a configuration diagram of an image display apparatus in each embodiment.

FIG. 2 is a configuration diagram of an eyepiece optical system in each embodiment.

FIG. 3 is an explanatory diagram of a direct ghost optical path.

### DESCRIPTION OF THE EMBODIMENTS

Referring now to the accompanying drawings, a detailed description will be given of embodiments according to the present invention.

In explaining each embodiment of the present invention, the polarization state and phase difference of light will be described, but states represented by concepts, such as linearly polarized light, circularly polarized light, elliptically polarized light, and a phase difference of λ/4, generally mean a wide state with a certain range. Thus, these errors do not hinder the essential effect of the present invention. A phase difference generated in each optical element is a phase difference with respect to light having a wavelength λ, and an arbitrary wavelength in the visible light region can be selected as the wavelength λ, which is, for example, but not limited to λ=580 nm.

### First Embodiment

Referring now to FIG. 1, a description will be given of an image display apparatus according to a first embodiment of the present invention. FIG. 1 is a configuration diagram of an image display apparatus 101 according to this embodiment. In FIG. 1, reference numeral 101 denotes an image display apparatus, which can be properly mounted on a head together with a mount mechanism (not shown) and the like. The image display apparatus 101 is also referred to as a head mounted display (HMD) when it is mounted on the head. Reference numeral 102 denotes a right eye of an observer and reference numeral 103 denotes a left eye of the observer. A second lens unit 104 and a first lens unit 105 constitute an eyepiece optical system for the right eye. A second lens 106 and a first lens 107 constitute an eyepiece optical system for the left eye. Reference numeral 108 denotes an image display element (right-eye image display element), and reference numeral 109 denotes an image display element (left-eye image display element), such as an organic EL display, but the present invention is not limited to this example.

The right-eye eyepiece optical system magnifies and projects the original image displayed on the image display element 108 as a virtual image and guides it to the observer's right eye 102. The left-eye eyepiece optical system magnifies and projects the original image displayed on the image display element 109 as a virtual image and guides it to the observer's left eye 103. A focal length F1 of the right-eye eyepiece optical system and the left-eye eyepiece optical system is 12 mm, a horizontal display angle of view is 45°, a vertical display angle of view is 34°, and a diagonal display angle of view is 54°. A distance (eye relief) E1 between the eyepiece and the observer's eyeball is 18 mm.

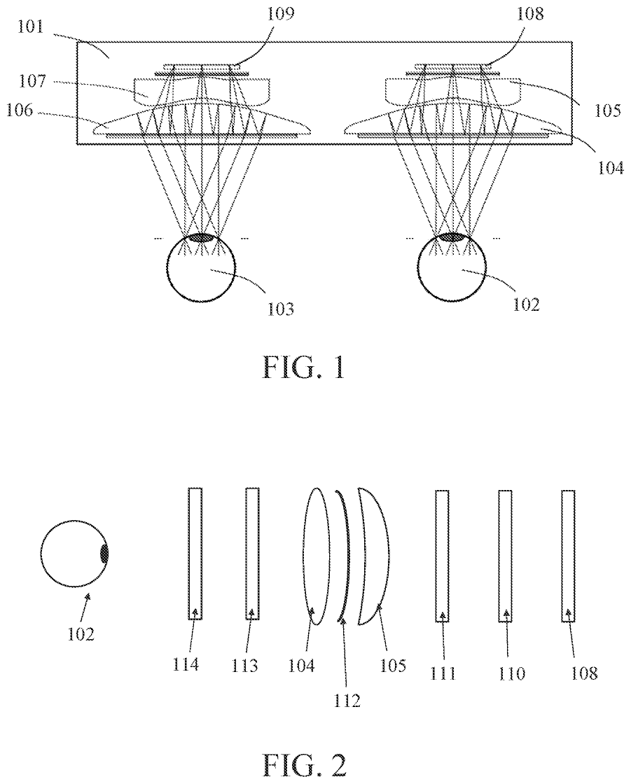

Referring now to FIG. 2, a description will be given of the eyepiece optical system of the image display apparatus 101 and its optical path. FIG. 2 is a block diagram of the eyepiece optical system according to this embodiment. The eyepiece optical system in this embodiment is an optical system configured to fold an optical path using polarized light, and guide light from the display element configured to display an image to an observer. Although FIG. 2 illustrates only the right-eye eyepiece optical system, the configuration of the left-eye eyepiece optical system is the same as that of the right-eye eyepiece optical system and a description thereof will be omitted.

Between the image display element 108 and the first lens unit 105, the polarizing plate 110 and the first phase plate 111 are arranged in order from the image display element 108 toward the observer's right eye 102. A half-transmissive reflective film (half-transmissive reflective surface) 112 is disposed between the second lens unit 104 and the first lens unit 105. The half-transmissive reflective film 112 is made of a metal film, a dielectric film, or the like, and is an optical surface in the second lens unit 104 an optical surface in the first lens unit 105, or a single substrate, if necessary.

A second phase plate 113 and a PBS (reflective and transmissive polarizing plate) of the reflective polarizing plate 114 are arranged in order from the image display element 108 between the second lens unit 104 and the observer's right eye 102. The second phase plate 113 and the PBS 114 of the reflective polarizing plate each have a planar shape. The configurations of the first lens unit 105 and the second lens unit 104 are properly selected according to the optical design, and include one or more lenses, respectively. In this embodiment, both the first lens unit 105 and the second lens unit 104 are provided, but this embodiment is applicable to a case where only one of the first lens unit 105 and the second lens unit 104 is provided.

A description will now be given of an ideal state in which none of the first lens unit 105 and the second lens unit 104 have birefringence characteristics. In this case, the transmitting polarization direction of the polarizing plate 110 and the slow axis of the first phase plate 111 tilt by 45°, and the transmitting polarization direction of the polarizing plate 110 and the slow axis of the second phase plate 113 tilt by −45°. The transmitting polarization direction of the polarizing plate 110 and the transmitting polarization direction of the PBS 114 are orthogonal to each other. Each of the first and second phase plates has a phase difference of λ/4.

In the case of such a configuration, light emitted from the image display element 108 passes through the polarizing plate 110 and becomes linearly polarized light, and passes through the first phase plate 111 and becomes circularly polarized light. This circularly polarized light passes as circularly polarized light through the first lens unit 105, passes through the half-transmissive reflective film 112, then passes as circularly polarized light through the second lens unit 104, then passes through the second phase plate 113 and becomes linearly polarized light. Since the polarization direction of this linearly polarized light is orthogonal to the transmitting polarization direction of the PBS 114, it is reflected by the PBS 114, again passes through the phase plate 113, and becomes circularly polarized light. This circularly polarized light passes as circularly polarized light through the second lens unit 104, is reflected by the half-transmissive reflective film 112, again passes as circularly polarized light through the second lens unit 104, passes through the second phase plate 113, and becomes linearly polarized light. However, the polarization direction of this linearly polarized light is different from the above one and coincides with the transmitting polarization direction of the PBS 114, and thus is guided through the PBS 114 to the observer's right eye 102. It can be said that the polarization state of light when none of the first lens unit 105 and the second lens unit 104 have birefringence characteristics is an ideal polarization state in principle.

In one conceivable configuration, the slow axis direction of the second phase plate 113 is 45° and the polarization characteristic direction of the PBS 114 is tilted by 90°, but this configuration may be properly selected and a detailed description thereof will be omitted. As described above, the optical system that folds the optical path using polarized light is thin, but the focal length of the eyepiece optical system can be shortened, and wide-angle image observation can be realized.

The image display apparatus 101 may be worn on the head and thus may be lightweight. As a method for reducing the weight, it is conceivable to manufacture a lens constituting the eyepiece optical system with a resin having a specific gravity smaller than that of glass. The resin lens can be produced by molding using a thermoplastic resin, and can be inexpensively mass-produced while realizing an aspherical shape that is advantageous for aberrational corrections. Therefore, a molded lens is generally used as the resin lens.

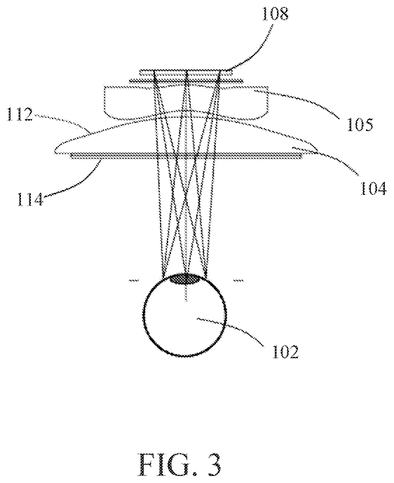

However, birefringence characteristics due to residual stress etc. during molding tend to remain in the molded lens, and when a birefringent lens is used for the first lens unit 105 or the second lens unit 104 in this embodiment, a phase difference is added when the light passes, and the intended polarization state cannot be maintained. As a result, rather than the regular optical path illustrated in FIG. 1, direct ghost light that is guided to the observer's eye without being reflected by the PBS 114 is generated as illustrated in FIG. 3. FIG. 3 is an explanatory diagram of the direct ghost light.

Since an unnecessary phase difference is added even in the regular optical path after being reflected by the PBS 114, part of the light that is to finally transmit through the PBS 114 is reflected, and an image becomes darker (dimmed) during observations. In order to reduce the birefringence of resin lenses, measures such as a lens material, a molding condition, and post-molding annealing, are known, but these measures have difficulty in sufficiently reducing the direct ghost light and dimming in an optical system configured to fold an optical path using polarized light.

Next follows a description of a configuration of the eyepiece optical system in this embodiment, but it is assumed that characteristics of parts unless otherwise specified are the same as the configuration in the ideal state. In this embodiment, for a weight reduction, the first lens unit 105 has at least one resin lens (lens made of a resin material) with birefringence. The phase difference given by the birefringence of the resin lens is λ/30. In consideration of this effect, this embodiment sets the phase difference given by the first phase plate 111 to λ/4-λ/30. In other words, the sum of the phase difference given by the first lens unit 105 and the phase difference given by the first phase plate 111 is λ/4 (approximately λ/4). Herein, the sum of the phase difference means the sum of the phase differences (optical effects) given to light that has passed through the first lens unit 105 and the first phase plate 111. Thereby, the phase difference applied to the light emitted from the image display element 108 and the polarizing plate 110 to the half-transmissive reflective film 112 becomes λ/4 (approximately λ/4) as in the ideal polarized state.

In this embodiment, approximately λ/4 falls within a range from 3λ/20 to 7λ/20 inclusive (λ/4±λ/10). That is, the sum of the phase difference of the light having the wavelength λ from the image display element 108 generated by the first phase plate 111 and the phase difference generated by the first lens unit 105 is 3λ/20 or more and 7λ/20 or less. In other words, the following conditional expressions (1) and (2) are satisfied:

ΔP1≠λ/4 (1)

3λ/20≤ΔP1+ΔL1≤7λ/20 (2)

where λ (nm) is a wavelength of the light, ΔP1 is a phase difference given by the first phase plate 111 to the light, and ΔL1 is a phase difference given by the first lens unit 105 to the light.

The conditional expression (1) may be set in the numerical range of the following conditional expression (1a):

3λ/20<ΔP1<λ/4 or λ/4<ΔP1<7λ/20 (1a)

The sum of the phase difference generated by the first phase plate 111 and the phase difference generated by the first lens unit 105 may fall within a range from 23λ/100 to 27λ/100 inclusive (λ/4±λ/50). The sum of the phase difference generated by the first phase plate 111 and the phase difference generated by the first lens unit 105 may fall within a range from 24λ/100 to 26λ/100 inclusive (λ/4±λ/100). The sum of the phase differences may be approximately λ/4 at the central part of the first phase plate 111 (near the optical axis in a case of a rotational symmetry). The phase differences generated in the resin lens may be in a range of, for example, λ/50<|ε|, λ/100<|ε|, or λ/200<|ε|.

The polarization state of light will be more specifically described: The light emitted from the image display element 108 passes through the polarizing plate 110 and becomes linearly polarized light, and passes through the first phase plate 111 and becomes elliptically polarized light. This elliptically polarized light passes through the first lens unit 105 having birefringence characteristic and becomes circularly polarized light. The circularly polarized light that has passed through the first lens unit 105 passes through the half-transmissive reflective film 112, then passes as circularly polarized light through the second lens unit 104, then passes through the second phase plate 113, and becomes linearly polarized light. If the phase difference of the first phase plate 111 remains λ/4, the light that has transmitted through the second phase plate 113 becomes elliptically polarized light rather than linearly polarized light, but it becomes ideally linearly polarized light due to the effect of the present invention. Since the polarization direction of this linearly polarized light is orthogonal to the transmitting polarization direction of the PBS 114, all light is reflected by the PBS 114 without generating direct ghost light, and again passes through the phase plate 113 to become circularly polarized light. This circularly polarized light passes as circularly polarized light through the second lens unit 104, is reflected by the half-transmissive reflective film 112, again passes as circularly polarized light through the second lens unit 104, passes through the second phase plate 113, and then becomes linearly polarized light. Since the polarization direction of this linearly polarized light is different from the above direction and coincides with the transmitting polarization direction of the PBS 114, it transmits through the PBS 114 and is guided to the observer's right eye 102.

As described above, in this embodiment, although the first lens unit 105 has the birefringence characteristic, no direct ghost light is generated. The phase characteristic of the first phase plate 111 and the phase characteristic of the first lens unit 105 do not affect the regular optical path after the light is reflected by the PBS 114. Therefore, even if the characteristic of the first phase plate 111 deviate from the ideal state as in this embodiment, there is no influence such as dimming.

When the birefringence characteristic of the resin lens changes according to the temperature, the sum of the phase differences may be set in consideration of the temperature. For example, within the temperature range of the resin lens when the image display apparatus 101 is used, the sum of the phase difference given by the first lens unit 105 and the phase difference given by the first phase plate 111 at a temperature at which the image display apparatus 101 is actually frequently used is set to λ/4. For example, when the temperature of the resin lens is a certain temperature in a range from 10° C. to 70° C. inclusive, the sum of the phase differences is set to be approximately λ/4 (so that the sum of the phase differences may be approximately λ/4 at a certain temperature from 10° C. to 70° C. inclusive). Thereby, since no direct ghost light is not generated in the actually usable temperature range, a good image can be practically observed with less direct ghost light.

In general, the birefringence of a lens increases from the center to the periphery of the lens, so that the direct ghost light caused by the birefringence of the lens also increases in intensity from the center to the periphery. Therefore, in order to reduce the direct ghost light passing through the peripheral part of the lens, the phase characteristic of the first phase plate 111 may have an in-plane distribution. For example, assume that the phase difference distribution in the region affecting the direct ghost light of the resin lens is λ/100 at the central part and λ/20 at the peripheral part. Then, the phase difference distribution in the region affecting the direct ghost light of the first phase plate 111 may be set to λ/4-λ/100 at the central part and λ/4-λ/20 at the peripheral part, or the phase differences ΔP1 are made different between the central part and the peripheral part.

Even if it is difficult to consider the birefringence state of the lens to be a constant value due to the influences of the temperature, individual differences, etc., a phase difference variable element can be used for the first phase plate 111 in order to sufficiently suppress the direct ghost light. The phase difference variable element can use, but is not limited to, a device made of a liquid crystal material and capable of realizing an arbitrary phase difference by supplying the electric power or a device whose phase difference changes when the voltage is applied. When the phase difference variable element is used, even if there are individual differences in the birefringence characteristics due to birefringence state changes and manufacturing variations of the lens, proper controlling the phase amount to be applied can prevent direct ghost light and dimming caused by the birefringence. The influence of the distribution of the lens birefringence can be cancelled by giving the phase difference variable element itself an in-plane distribution. In order to reduce the ghost light of external light and to increase the contrast of the observed image, a polarizing plate may be disposed between the PBS 114 and the eyeball of the observer's right eye 102.

In this embodiment, the image display element is an image display element as an organic EL that emits unpolarized light, but the present invention is not limited to this example. For example, by using the image display element as a liquid crystal display to radiate linearly polarized light, the polarizing plate 110 on the image display element side becomes unnecessary, and the low profile and cost reduction can be realized.

### Second Embodiment

Referring now to FIG. 2, a description will now be given of a configuration of the eyepiece optical system according to a second embodiment of the present invention. In this embodiment, the configuration of the image display apparatus is the same as that of the first embodiment described with reference to FIG. 1, so a description thereof will be omitted.

In this embodiment, for a weight reduction, the second lens unit 104 has at least one resin lens having birefringence. Unless otherwise specified, the characteristics of parts have a configuration that is the same as that in the ideal state. The phase difference given by the birefringence of the resin lens is −λ/20. In consideration of this effect, this embodiment sets the phase difference given by the second phase plate 113 to λ/4+λ/20. In other words, the sum of the phase difference given by the second lens unit 104 and the phase difference given by the second phase plate 113 is λ/4 (approximately λ/4). Thereby, when the light emitted from the image display element 108 travels, the phase difference given from the half-transmissive reflective film 112 to the PBS 114 is λ/4 (approximately λ/4), as in the ideal polarized state.

In this embodiment, approximately λ/4 is within a range from 3λ/20 to 7λ/20 inclusive (λ/4±λ/10). That is, with respect to the light having the wavelength λ from the image display element 108, the sum of the phase difference generated by the second phase plate 113 and the phase difference generated by the second lens unit 104 is 3λ/20 or more and 7λ/20 or less. In other words, the following conditional expressions are satisfied:

ΔP2≠λ/4 (3)

3λ/20≤ΔP2+ΔL≤7λ/20 (4)

where λ (nm) is a wavelength of the light, ΔP2 is a phase difference given by the second phase plate 113 to the light, and ΔL is a phase difference given by the second lens unit 104 to the light.

The conditional expression (3) may be replaced with the numerical range in the following conditional expression (3a).

3λ/20<ΔP2<λ/4 or λ/4<ΔP2<7λ/20 (3a)

The sum of the phase difference generated by the second phase plate 113 and the phase difference generated by the second lens unit 104 may be in the range from 23λ/100 to 27λ/100 inclusive (λ/4±λ/50). The sum of the phase difference generated by the second phase plate 113 and the phase difference generated by the second lens unit 104 may be in the range from 24λ/100 to 26λ/100 inclusive (λ/4±λ/100). The sum of the phase differences may be approximately λ/4 at the central part of the second phase plate 113 (optical axis in case of a rotational symmetry). The phase difference ε generated in the resin lens may be, for example, in a range of λ/50<|ε|, λ/100<|ε|, or λ/200<|ε|.

The polarization state of light will be more specifically explained. The light emitted from the image display element 108 passes through the polarizing plate 110 and becomes linearly polarized light, and after passing through the first phase plate 111, becomes circularly polarized light. This circular polarization passes as circularly polarized light through the first lens unit 105, passes through the half-transmissive reflective film 112, then passes through the second lens unit 104, and becomes elliptically polarized light due to the birefringence characteristic of the resin lens. This elliptically polarized light passes through the second phase plate 113 whose phase difference is adjusted as described above and becomes linearly polarized light. If the phase difference of the second phase plate 113 remains λ/4, the light that has transmitted through the second phase plate 113 becomes elliptically polarized light rather than linearly polarized light, but it is ideally linearly polarized light due to the effect of the present invention.

Since the polarization direction of this linearly polarized light is orthogonal to the transmitting polarization direction of the PBS 114, all light is reflected by the PBS 114 without generating direct ghost light, again passes through the phase plate 113, and becomes elliptically polarized light. When the elliptically polarized light passes through the second lens unit 104, it becomes circularly polarized light due to the birefringence characteristic of the resin lens, is reflected by the half-transmissive reflective film 112, again passes through the second lens unit 104, and becomes elliptically polarized light. This elliptically polarized light becomes linearly polarized light when it passes through the second phase plate 113 whose phase difference is adjusted. If the phase difference of the second phase plate 113 remains λ/4, the light that has passed through the second phase plate 113 becomes elliptically polarized light rather than linearly polarized light, and part of the light is reflected by the PBS 114. That is, dimming occurs. On the other hand, according to this embodiment, since the light that has transmitted through the second phase plate 113 is linearly polarized light with the transmitting polarization direction of the PBS 114, all light passes through the PBS 114 without causing dimming and is guided to the observer's right eye 102. As described above, in the eyepiece optical system in this embodiment, although the second lens unit 104 has the birefringence characteristic, no direct ghost light is generated or no dimming is caused by the birefringence characteristic.

When the birefringence characteristic of the resin lens changes according to the temperature, the sum of the phase differences may be set in consideration of the temperature. For example, within the temperature range of the resin lens when the image display apparatus 101 is used, the sum of the phase difference given by the second lens unit 104 and the phase difference given by the second phase plate 113 at a temperature at which the image display apparatus 101 is actually frequently used is set to λ/4. For example, when the temperature of the resin lens is a certain temperature in a range from 10° C. to 70° C. inclusive, the sum of the phase differences is set to approximately λ/4. Thereby, since no direct ghost light is generated in the actually usable temperature range, a good image can be practically observed with less direct ghost light.

In general, the birefringence of the lens increases from the center to the periphery of the lens, so that the direct ghost light caused by the birefringence of the lens also increases in intensity from the center to the periphery. Thus, in order to reduce the direct ghost light passing through the peripheral part of the lens, the phase characteristic of the second phase plate 113 may have an in-plane distribution. For example, assume that the phase difference distribution in the region affecting the direct ghost light of the resin lens is λ/100 at the central part and λ/20 at the peripheral part. Then, the phase difference distribution in the region affecting the direct ghost light of the second phase plate 113 may be set to λ/4-λ/100 at the central part and λ/4-λ/20 at the peripheral part.

Even if it is difficult to consider the birefringence state of the lens to be a constant value due to the influences of the temperature, individual differences, etc., a phase difference variable element can be used for the second phase plate 113 in order to sufficiently suppress the direct ghost light. The phase difference variable element can use, but is not limited to, a device made of a liquid crystal material and capable of realizing an arbitrary phase difference by supplying the electric power. When the phase difference variable element is used, even if there are individual differences in the birefringence characteristics due to birefringence state changes and manufacturing variations of the lens, etc., proper controlling the phase amount to be applied can prevent direct ghost light and dimming caused by the birefringence. The influence of the distribution of the lens birefringence can be cancelled by giving the phase difference variable element itself an in-plane distribution. In order to reduce the ghost light of external light and to increase the contrast of the observed image, a polarizing plate may he disposed between the PBS 114 and the eyeball of the observer's right eye 102.

In this embodiment, the image display element is an image display element as an organic EL that emits unpolarized light, but the present invention is not limited to this example. For example, by using the image display element as a liquid crystal display to radiate linearly polarized light, the polarizing plate 110 on the image display element side becomes unnecessary, and the low profile and cost reduction can be realized.

### Third Embodiment

Referring now to FIG. 2, a description will he given of a configuration of the eyepiece optical system according to a third embodiment of the present invention. In this embodiment, the configuration of the image display apparatus is the same as that of the first embodiment described with reference to FIG. 1, and thus a description thereof will be omitted.

In this embodiment, in order to reduce the weight, a resin lens having a birefringence characteristic in each of the first lens unit 105 and the second lens unit 104 is used. The phase difference given by the birefringence of the resin lens used for the first lens unit 105 is λ/20, and the phase difference given by the birefringence of the resin lens used for the second lens unit 104 is λ/40. In consideration of these influences, this embodiment sets the phase difference given by the first phase plate 111 to λ/4-λ/20. In other words, the sum of the phase difference given by the first lens unit 105 and the phase difference given by the first phase plate 111 is λ/4 (approximately λ/4). Thereby, the total phase difference given to the light emitted from the image display element 108 to the half-transmissive reflective film 112 through the polarizing plate 110 is λ/4. Similarly, this embodiment sets the phase difference given by the second phase plate 113 to λ/4-λ/40. In other words, the sum of the phase difference given by the second lens unit 104 and the phase difference given by the second phase plate 113 is λ/4 (approximately λ/4). Thereby, the total phase difference given to the light emitted from the image display element 108 to the PBS 114 through the half-transmissive reflective film 112 is λ/4 (approximately λ/4). The range of approximately λ/4 and the polarization state in the optical path are the same as those in the first and second embodiments.

In this embodiment, although the first lens unit 105 and the second lens unit 104 each have birefringence characteristics, no direct ghost light or dimming occurs. Similar to the first and second embodiments, by giving the in-plane distribution to the first phase plate 111 and the second phase plate 113, the polarization state can be set to the ideal polarization state in consideration of the phase difference distribution of the resin lens. Similar to the first and second embodiments, a phase difference variable element can be used for each of the first phase plate 111 and the second phase plate 113.

Each embodiment can provide an optical system and an image display apparatus advantageous in reducing ghosts in an eyepiece optical system having a wide angle of view and light weight using polarized light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-015875, filed on Jan. 31, 2020 which is hereby incorporated by reference herein in its entirety.

What is claimed is:

1. An optical system configured to guide light from a display element configured to display an image to an observer, the optical system comprising, in order from a side of the display element, a polarizing plate, a first phase plate, a first lens unit, a half-transmissive reflective film, a second phase plate, and a reflective and transmissive polarizing plate,
wherein the first lens unit includes a lens made of a resin material, and
wherein the following conditions are satisfied:
ΔP1≠λ/4
3λ/20≤ΔP1+ΔL1≤7λ/20
where λ (nm) is a wavelength of the light, ΔP1 is a phase difference given by the first phase plate to the light, and ΔL1 is a phase difference given by the first lens unit to the light.

2. The optical system according to claim 1, wherein the light becomes linearly polarized light after passing through the polarizing plate, elliptically polarized light after passing through the first phase plate, and circularly polarized light after passing through the first lens unit.

3. The optical system according to claim 1, wherein the following condition is satisfied at a central part of the first phase plate:
3λ/20≤ΔP1+ΔL1≤7λ/20.

4. The optical system according to claim 1, wherein ΔP1 has different values between a central portion and a peripheral part of the first phase plate.

3. The optical system according to claim 1, wherein the following condition is satisfied:
3λ/20≤ΔP1+ΔL1≤7λ/20
where the lens has a temperature in a range from 10° C. to 70° C. inclusive.

6. The optical system according to claim 1, wherein the first phase plate is configured to change a value of ΔP1.

7. The optical system according to claim 1, wherein the following condition is satisfied:
3λ/20<ΔP1<λ/4 or λ/4<ΔP1<7λ/20.

8. The optical system according to claim 1, further comprising a second lens unit disposed between the second phase plate and the half-transmissive reflective film, the second lens unit including a lens made of a resin material,
wherein the following conditions are satisfied:
ΔP2≠λ/4
3λ/20≤ΔP2+ΔL2≤7λ/20
where ΔP2 is a phase difference given by the second phase plate to the light, and ΔL2 is a phase difference given by the second lens unit to the light.

9. The optical system according to claim 8, wherein the light becomes linearly polarized light after passing through the polarizing plate, elliptically polarized light after passing through the first phase plate, circularly polarized light after passing through the first lens unit, and elliptically polarized light after passing through the second lens unit, and linearly polarized light after passing through the second phase plate.

10. The optical system according to claim 8, wherein the following condition is satisfied:
λ/50<|ε|

where ε is a phase difference given by the lens to the light.

11. An image display apparatus comprising:
the optical system according to claim 1; and
a display element configured to display an image.

12. An optical system configured to guide light from a display element configured to display an image to an observer, the optical system comprising, in order from a side of the display element, a polarizing plate, a first phase plate, a half-transmissive reflective film, a lens unit, a second phase plate, and a reflective and transmissive polarizing plate,
wherein the lens unit includes a lens made of a resin material, and
wherein the following conditions are satisfied:
3λ/20≤ΔP2+ΔL≤7λ/20
ΔP2≠λ/4
where λ (nm) is a wavelength of the light, ΔP2 is a phase difference given by the second phase plate to the light, and ΔL is a phase difference given by the lens unit to the light.

13. The optical system according to claim 12, wherein the light from the display element becomes linearly polarized light after passing through the polarizing plate, circularly polarized light after passing through the first phase plate, elliptically polarized light after passing through the lens unit, and linearly polarized light after passing through the second phase plate.

14. The optical system according to claim 12, wherein the following condition is satisfied at a central part of the second phase plate:
3λ/20≤ΔP2+ΔL≤7λ/20.

15. The optical system according to claim 12, wherein ΔP2 has different values between a central portion and a peripheral part of the second phase plate.

16. The optical system according to claim 12, wherein the second phase plate is configured to change a value of ΔP2.

17. The optical system according to the claim 12, wherein the following condition is satisfied:
λ/50<|ε|

where ε is a phase difference given by the lens to the light.

18. An image display apparatus comprising:
the optical system according to the claim 12; and
a display element configured to display an image.
